(19) United States
(12) Patent Application Publication
(10) Pub. No.: US 2002/0080825 A1
(43) Pub. Date: Jun. 27, 2002

(54) Method and compensation module for the phase compensation of clock signals

(75) Inventors: Michael Joachim Wolf, Mundelsheim (DE); Werner Beisel, Ludwigsburg (DE); Jurgen Hohn, Abstatt (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 10/014,359

(22) Filed: Dec. 14, 2001

(30) Foreign Application Priority Data
Dec. 23, 2000 (DE) 100 64 929.7

(51) Int. Cl. H04J 3/06

(52) U.S. Cl. 370/517; 370/252

(57) ABSTRACT

A compensation module or for a network device of a telecommunications network delays a first clock signal by a predetermined first delay time to form a delayed first clock signal and delays a second clock signal by a predetermined second delay time to form a delayed second clock signal. The compensation module then adapts the second delay time so that the delayed second clock signal is adapted to the phase of the delayed first clock signal.

The invention is based on a priority application DE 10064929.7, which is incorporated by reference herein.

### FIELD OF THE INVENTION

The present invention relates to the fields of telecommunications and computer technology and more particularly to a method and a compensation module for phase compensation between at least one first clock signal and a second clock signal which are transmitted to the compensation module, which in particular is a compensation module in a telecommunications network or in a network node of a telecommunications network.

### BACKGROUND OF THE INVENTION

In the fields of telecommunications and computer technology, the assemblies required for the operation of a device often cannot be arranged on one electronic board but must be distributed between a plurality of separate modules on one or more respective boards. In particular in telecommunications systems, redundant modules are additionally used to safeguard against failure. For the modules to operate in synchronism, the modules receive a central clock signal which for example is generated by a central clock generator module and transmitted to the modules for example via a clock channel of a bus. The modules then operate either directly with the clock signal tapped from the bus or for example synchronise their own local clock generator, provided on the respective module, with the central clock signal.

In a system of redundant design, a module is however supplied not only with one clock signal but with at least one second clock signal. Even if it is assumed that the two clock signals are synchronous at their source, for example emanate from clock generators optimally synchronised with one another or both emanate from the same clock generator, when the transmission paths for the clock signals are of different length, for example due to cables of different length, phase differences occur when the two clock signals arrive at the module operating as clock signal sink. Then, for example upon the failure of one of the clock signals, the module cannot switch back and forth between the clock signals without a phase jump.

Although this could be countered by dimensioning the respective transmission paths to be of equal length, for example by the use of cables of equal length, in more complex systems spatially remote from one another this results in a considerable outlay for the construction and servicing of the systems. If precise synchronisation with no phase differences is to be performed in the case of spatially remote network devices of a telecommunications network, the length of the transmission paths for the respective clock signals generally cannot be influenced, or in individual cases can possibly be influenced only to a small extent. Additionally, the problem is exacerbated if the redundant clock signals are not exactly synchronous at the clock signal source.

In high-precision network devices, operating with a high clock frequency, of telecommunications networks, for example so-called cross-connects in SDH transmission technology (SDH=synchronous digital hierarchy), even very small phase shifts between clock signals or so-called frame clock signals have a disturbing effect on the precision of the network device. The modules of a network device, which for example consist of I/O assemblies (I/O=input/output) or switching matrices, then no longer operate sufficiently in synchronism, and messages passing through the modules of the network device are subject for example to data overtaking or overlaps.

These problems also occur in a telecommunications network when, for reasons of redundancy, network devices are synchronised with more than one clock signal.

### SUMMARY OF THE INVENTION

Therefore the object of the present invention is to provide a method and a compensation module for the phase compensation of phase differences which occur between at least one first, and a second clock signal transmitted to the compensation module.

This object is achieved by a compensation module which has a receiver for receiving at least one first clock signal and a second clock signal. The compensation module further contains first delay means for delaying the first clock signal by a first delay time, and second delay means for delaying the second clock signal by a second delay time. In addition, the compensation module contains adjusting means for the phase adjustment of the second delay means, so that the delayed, second clock signal, present at the output end of the second delay means, is adapted to the phase of the delayed first clock signal present at the output end of the first delay means.

The invention is based on the principle that the compensation module delays the at least one first clock signal by a predetermined first delay time to form a delayed first clock signal and delays the second clock signal by a predetermined second delay time to form a delayed second clock signal. The compensation module then adapts the second delay time so that the delayed second clock signal is adapted to the phase of the delayed first clock signal.

The first delay time is so-to-speak a basic delay which avoids the second clock signal, incoming to the compensation module possibly with a slight phase difference, having to be delayed virtually by one entire clock pulse length or, in the case of a so-called frame clock signal, by virtually one entire frame length. Additionally, the compensation module automatically adapts itself to the respective phase differences, so that, for example within limits defined by the respective individual design of the compensation module, it is possible to select transmission paths of any length for the clock signals. Thus for example one is no longer restricted to cables of equal length for the transmission of the clock signals, it being possible to use a short cable, for example of 20 centimetres length, for the first clock signal and a long cable, for example of 200 metres length, for the second clock signal.

Further advantageous developments of the invention are described in the dependent claims and in the description.

The invention can be used advantageously in any system with redundant clock distribution. The system can consist of one individual device or for example a communications network. In a particularly preferred embodiment the invention is employed in a transmission network, in particular a transmission network with a synchronous digital hierarchy (SDH) or in a network device of the transmission network, for example in a cross-connect of a SDH transmission network. The invention can also be used advantageously in a SONET network device (SONET=synchronous optical network) or in a PDH network device (PDH=plesiosynchronous digital hierarchy).

Compensation modules according to the invention consist for example of input/output modules or switching matrix modules of a network device, which in all events require precise synchronisation for smooth cooperation with one another or with other devices synchronised with the clock signals. It is also possible for a network node of a telecommunications network, for example a switching centre or cross-connect, to form a compensation module according to the invention and optionally comprise further components, for example a switching network or the like.

The delay time for the first clock signal is advantageously predetermined in accordance with a maximum expected phase difference between the first clock signal and the second clock signal. For this purpose, delay means assigned to the first clock signal are expediently designed such that they can delay the clock signal by at least a delay time corresponding to the maximum expected phase difference. For example, a shift register serving as delay means has a memory depth adapted to the first delay time. The phase difference results for example from propagation time differences in the case of transmission paths of different length used to transmit the two clock signals. In the above example it would then be necessary to calculate a propagation time difference and corresponding phase difference for a cable of approximately 200 metres.

A start value corresponding to the first delay time is expediently selected for the second delay time. Thus a delay time corresponding to the maximum expected phase difference is set, although in principle other start values are also possible. In the subsequent adaptation of the second delay time, this can on the one hand be reduced to the value “0”, i.e. if the second clock signal is received by the compensation module lagging the first clock signal by the said phase difference. On the other hand, the second delay time can also amount to double the first delay time, i.e. if the second clock signal is received by the compensation module leading the first clock signal by the said phase difference.

Accordingly, in contrast to the first delay means assigned to the first clock signal, the delay means assigned to the second clock signal are at least designed such that they can delay the second clock signal by at least double a delay time corresponding to the maximum expected phase difference between the two clock signals. Then for example, a shift register serving as second delay means has double the memory depth compared to the above mentioned shift register serving as first delay means.

It will be obvious that the above details about the delay means are in each case expedient minimum values and that both delay means can be of similar construction for reasons of universal usability.

In principle, for clock signals incoming to the compensation module it can be predetermined, for example by wiring-defined co-ordination, as to which of the clock signals is the first clock signal and which is the second clock signal in terms of the procedure according to the invention.

Expediently however, the compensation module comprises selection means with which it can in each case select one of the clock signals as first clock signal and one as second clock signal. Advantageously, the selected clock signal serves to synchronise the compensation module.

Advantageously, for example, the respective leading clock signal is selected as first clock signal.

It is also possible to specify to the compensation module, by means of an item of master-slave-status information which is sent from the exterior, as to which of the clock signals is to be selected as a master synchronisation signal for the synchronisation of the compensation module. The master-slave-status information can for example be inserted, so-to-speak as “in-band” identifier, in each clock signal or for example also only in the clock signal to be selected as “master”. The master-slave-status information can also be sent to the compensation module via control data separate from the clock signals. In any case, the receiving means are suitable to receive the master-slave-status information, and the selection means are expediently designed such that, as a function of the master-slave-status information, the compensation module can select the at least one first clock signal or the second clock signal as a master synchronisation signal for its synchronisation.

The respective clock signal selected as master synchronisation signal expediently also serves as the first clock signal assigned to first delay means.

In principle the phase adjustment could also take place in accordance with different methods. Here advantageously the relevant phase difference between the delayed clock signals made available by the delay means is measured, whereupon the second delay time is adapted to the respective determined phase difference. Continuous control, or also the use of so-called fuzzy logic, are conceivable here for example. Expediently the phase adjustment is performed in stepped fashion, it being possible to use digital components and/or control implemented as software.

In the stepped phase adjustment the second delay time could in principle be changed with constant step sizes, the determined phase difference basically being adequately defined by two values for control purposes: “second clock signal leads first clock signal” or “second clock signal lags first clock signal”. A third value, “first and second clock signal are in phase” is advantageous in terms of the control non-operation.

For the phase adjustment it has proved particularly advantageous to change the second delay time in dynamic step sizes, the respective step size being modified as a function of a respective phase difference between the delayed clock signals present at the output end of the delay means. In the case of a large phase difference the step size is large, whereas in the case of a smaller phase difference it is correspondingly smaller. Expediently the second delay time is not modified in the case of only very small phase difference values approaching “0”. Advantageously, two further values are added to the above three values for the phase difference: “second clock signal substantially leads first clock signal” or “second clock signal substantially lags first clock signal”. In any case, this results on the one hand in a rapid reduction in the phase difference and on the other hand in a high degree of stability and control non-operation.

In particular with multiple switching back and forth between the first and second clock signal, in the case of which the phase of the respective unselected clock signal must be adapted to the phase of the selected clock signal, a so-called creeping effect occurs. With this effect the first and second delay times assigned to the first and second clock signal respectively are increased or reduced in the same direction, so that ultimately the first and second delay means may no longer be able to adjust the respective first and second delay times required for a phase compensation. In the above described example, the memory capacity of the shift registers would for example no longer be adequate. Especially in the case of systems operated for very long periods, which for example operate continuously for many years, the creeping effect leads to problems. Units in which phase compensation means are provided and which are optionally supplied by the first and second clock signals also might not be able to perform a required phase compensation, for example due to the capacity of their phase compensation means. Additionally, an increasing first and second delay time undesirably increase the total propagation time of the first and second clock signals respectively.

In a preferred variant of the invention, this is countered in that the adjusting means are designed to preferentially adjust the first delay time and/or second delay time to a respective first or second start value which is either preset or is determined upon each start-up of the compensation module, where a modification of the first delay time or second delay time, which increases the deviation of the first delay time or second delay time from the first or second start values, is performed only upon the attainment of a predetermined first deviation tolerance value, while the converse applies upon the attainment of a second deviation tolerance value which is smaller than the first deviation tolerance value.

In the above example a first start value corresponding to the first delay time governs, for example, the scanning of the shift register serving as first delay means. This can for example be a preset start value or can be determined upon the first start-up of the compensation module. Then the delayed second clock signal present at the output end of the second delay means is adapted to the phase of the delayed, at least one first clock signal present at the output end of the first delay means. For example in the event of a fault in the first clock signal, a switch-over takes place to the second clock signal. If however the first clock signal is re-available later, its phase is adapted to the phase of the now selected, second clock signal. Here the compensation module orients itself to the originally set, first start value for the first delay means. If, for the correction of a phase difference of the first clock signal, the reference value for scanning the shift register serving as first delay means needed to be modified in the direction of a larger deviation from the first start value, this phase difference must be relatively large. Conversely, in the event of a change in the reference value in the direction of the first start value, the reference value is modified even in the case of small phase differences. In this way, so to speak a preferred direction in the direction of the first start value is defined for the phase compensation.

It will be obvious that this procedure can be employed correspondingly also for a start value assigned to the second delay means. Then the second start value is preferably that value of the second delay time which has been determined on the first phase adjustment of the second delay means upon the start-up of the compensation module.

The compensation module according to the invention can also be implemented as a software module or program module whose program code can be executed by a suitable control means, for example a digital signal processor.

Obviously it is also possible to process more than two clock signals in accordance with the invention. The determination of the delay times and the design of the delay means are then for example based on a maximum phase difference which can occur between the clock signals incoming in the compensation module as first and last in respect of phase. If it is assumed that the compensation module is designed using transmission paths of different length for the clock signals, for example transmission cables of different length, the delay means can be designed in accordance with a transmission time difference occurring between the longest and shortest cable or—even simpler—in accordance with the transmission time which occurs when the longest cable is used.

### BRIEF DESCRIPTION OF THE DRAWINGS

In the following the invention and its advantages will be explained in the form of an exemplary embodiment making reference to the drawing in which:

FIG. 1 illustrates an example of an arrangement for the execution of the method according to the invention with a network device NWE according to the invention comprising compensation modules MOD1, MOD2 and clock generator modules GEN1, GEN2 according to the invention,

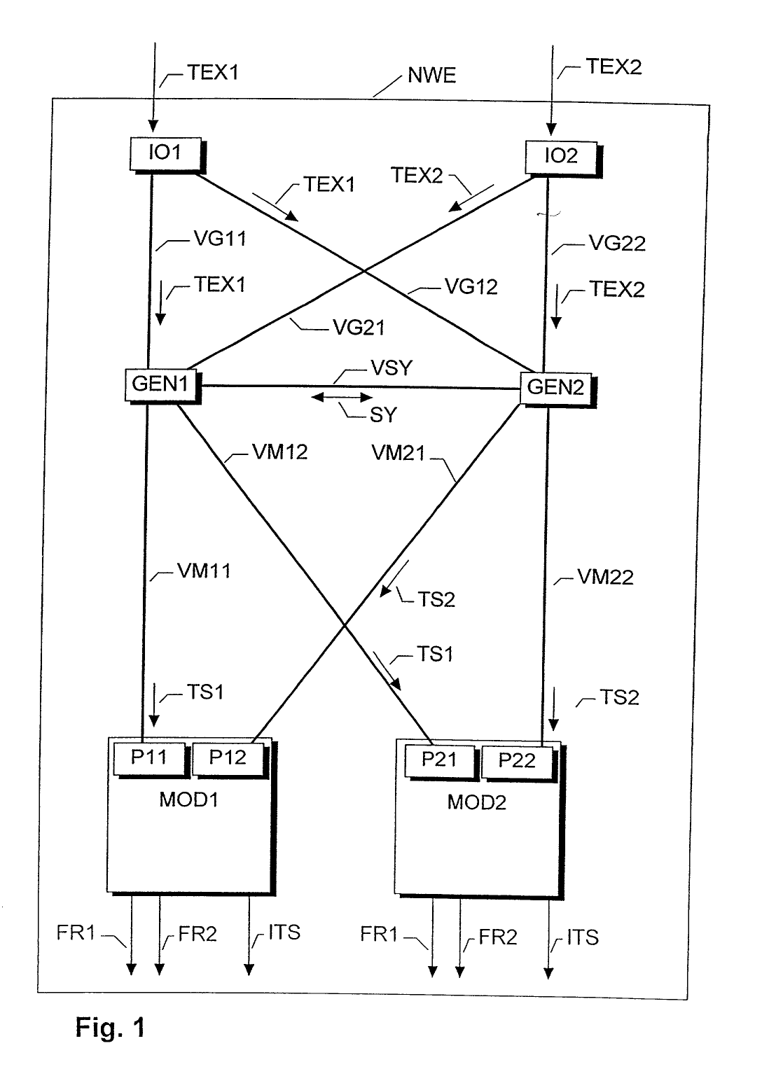

FIG. 2 is a schematic diagram of the compensation module MOD1,

FIGS. 3a, 3b are schematic propagation time diagrams for clock signals TS1, TS2 corresponding to processing by the compensation module MOD1 shown in FIGS. 1, 2 and

FIG. 4 illustrates an analysis of phase differences between the clock signals TS1, TS2 according to FIGS. 3a, 3b.

### DETAILED DESCRIPTION IF THE INVENTION

A network device NWE contains compensation modules MOD1, MOD2 which are supplied with clock signals TS1, TS2 by clock generator modules GEN1, GEN2. Apart from possible phase differences, the clock signals TS1, TS2 are mutually redundant clock signals, from which the compensation modules MOD1, MOD2 select one as master synchronisation signal for their synchronisation.

The network device NWE consists of a network node of a transmission network, for example a cross-connect of a SDH transmission network. The network device NWE receives data, for example so-called SDH frames, by means of so-called I/O ports IO1, IO2 (I/O=input/output) serving as receiving means, on transmission paths (not shown) which for example are provided on SDH transmission lines. The data, for example the SDH frames, comprise on the one hand payload data and on the other hand control data which are contained for example in their so-called overhead and in the present case contain (external) clock signals TEX1, TEX2. The clock signals TEX1, TEX2 could also be determined for example from the transmission rate and/or structure of the data received at the I/O ports IO1, IO2 or received on separate clock signal lines (not shown) by the network device NWE. The I/O ports IO1, IO2 are input/output modules, implemented for example as integrated circuits, which are arranged for example on an interface card. The I/O ports IO1, IO2 are input/output modules, implemented for example as integrated circuits, which are arranged for example on an interface card.

In the present case the clock generator modules GEN1, GEN2 have the form of mutually redundant clock generator modules and can be arranged for example on a central control console or control computer of the network device NWE or on a respective separate console.

The compensation modules MOD1, MOD2 to be synchronised consist for example of input/output assemblies, switching matrices or stages thereof or of other modules which must operate in synchronism for the smooth operation of the network device NWE.

From the I/O port IO1 the (external) clock signal TEX1 is sent via connections VG11, VG12 to the clock generator modules GEN1, GEN2, and from the I/O port IO2 the clock signal TEX2 is sent via connections VG21, VG22 to the clock generator modules GEN1, GEN2. The clock generator modules GEN1, GEN2 select that one of the clock signals TEX1, TEX2 with the best respective clock quality. The respective clock quality is contained for example as so-called “synchronisation status message” (SSM) in SDH frames and can thus be determined by the I/O ports IO1, IO2 and/or the clock generator modules GEN1, GEN2. In accordance with the SDH standards of the ETSI (=European Telecommunications Standards Institute), in descending order of quality the SSM can have the following meanings for example: “primary reference clock”, “transit node”, “local node”, “SDH equipment clock” and “do not use”. These and further synchronisation status messages (SSMs) for SDH- and SONET transmission networks are standardized by the ITU (International Telecommunication Union).

Using clock generating means (not shown), for example with so-called phase locked loops (PLL), from the clock signals TEX1, TEX2 serving so-to-speak as basic clock signals, the clock generator modules GEN1, GEN2 generate the clock signals TS1, TS2 which in the present case are so-called frame clock signals and are transmitted with a bit rate of 2 megabits per second. The frame clock signals TS1, TS2 contain a plurality of base frames which are cyclically repeated, for example with a frequency of 8 Kilohertz (kHz), and which themselves serve as clock signals. The base frames, which for example are cyclically transmitted at 8 kHz, contain quality identifiers and further synchronisation signals or frames, for example a 1 Hz clock signal. The 1 Hz clock signal can consist for example of one bit in the base frame which changes between the values “0” and “1” every 500 milliseconds. The quality identifiers consist for example of individual bits or bit sequences and in the present case comprise an item of master-slave-status information MSX and optionally further identifiers, for example the above explained SSM identifier, which is sent from the I/O ports IO1, IO2 to the clock generator modules GEN1, GEN2, or identification codes which are inserted by the I/O ports IO1, IO2 and/or the clock generator modules GEN1, GEN2 and with the aid of which possible wiring errors between the modules of the network device NWE can be detected and eliminated.

In the present case the clock generator modules GEN1, GEN2 synchronise one another, reciprocally sending one another, via a connection VSY, synchronisation data SY serving as synchronisation signals. The clock generator modules GEN1, GEN2 also negotiate as to which of the two modules operates as master clock generator module and which as slave clock generator module. Accordingly, the clock generator modules GEN1, GEN2 set the master-slave-status information MSX in the clock signals TS1, TS2 at the values “master” and “slave”, for example logic “1” and “0”. In the present case the items of master-slave-status information MSX have been depicted in frames FRTS1a, FRTS1da of the clock signals TS1, TS1d by way of example.

The clock generator modules GEN1, GEN2 transmit the clock signals TS1, TS2 via connections VM11, VN12; VM21, VM22 to the compensation modules MOD1, MOD2. The compensation module MOD1 receives the clock signals TS1, TS2 at inputs or ports P11 and P12 respectively which form receiving means and for example contain integrated circuits for data reception in accordance with the RS485 interface definition. Accordingly, the compensation module MOD2 receives the clock signals TS1, TS2 via inputs or ports P21 and P22 respectively.

As a function of the clock signal TS1 or TS2 in which the master-slave-status information MSX is set at “master”, the compensation modules MOD1, MOD2 select the clock signal TS1 or the clock signal TS2 as master-synchronisation signal and synchronise themselves therewith. In principle however it is also possible for the compensation modules MOD1, MOD2 to select one of the clock signals TS1, TS2 as master synchronisation signal in accordance with a fixed predetermination or on the basis of other criteria or also at random. For example the particular clock signal TS1, TS2 which leads in phase could be selected as master synchronisation signal.

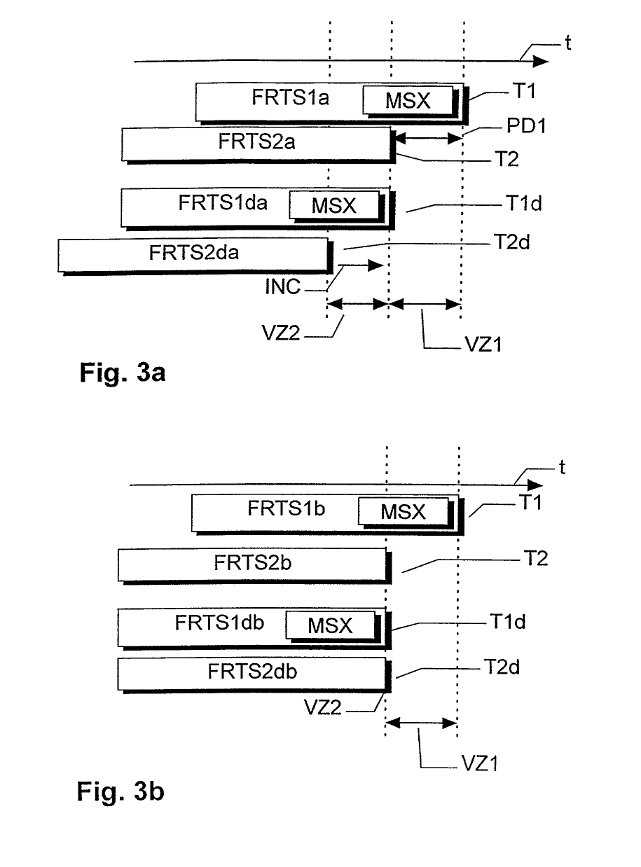

A possible sequence of operations for a phase compensation according to the invention by the compensation modules MOD1, MOD2 will be explained in the following with reference to FIGS. 3a, 3b.

Frames FRTS1a and FRTS2a, which are assigned to the clock signals TS1, TS2 and which arrive in the compensation module MOD1 at the respective times T1a and T2a, are entered in parallel to a time axis t. Accordingly, the clock signal TS1 leads the clock signal TS2 by a phase difference time PD1, for example because the transmission path VM11 is shorter than the transmission path VM21. The compensation module MOD1 delays the clock signal TS1 by a delay time VZ1 corresponding to the phase difference time PD1, and delays the clock signal TS2 by a delay time VZ2 which in the present case is shorter than the delay time VZ1 but in principle can also be equal to or greater than the latter. The time-delayed clock signals TS1d, TS2d are shown as frames FRTS1da and FRTS2da. To reduce the phase difference PD1 corresponding to the delay time VZ1, the clock signal TS2 or the frame FRTS2da must be moved forwards in time, as indicated by an arrow INC.

The result of such a time adaptation is illustrated in FIG. 3b. Frames FRTS1db and FRTS2db, which follow the frames FRTS1a and FRTS2a respectively, arrive at the input end of the compensation module MOD1. As previously, the clock signal TS1 is delayed by the delay time VZ1. In contrast to the situation shown in FIG. 3a, the delay time VZ2 is reduced to “0” so that the time-delayed clock signals TS1d, TS2d are in phase, illustrated in FIG. 3b by respective frames FRTS1db and FRTS2db.

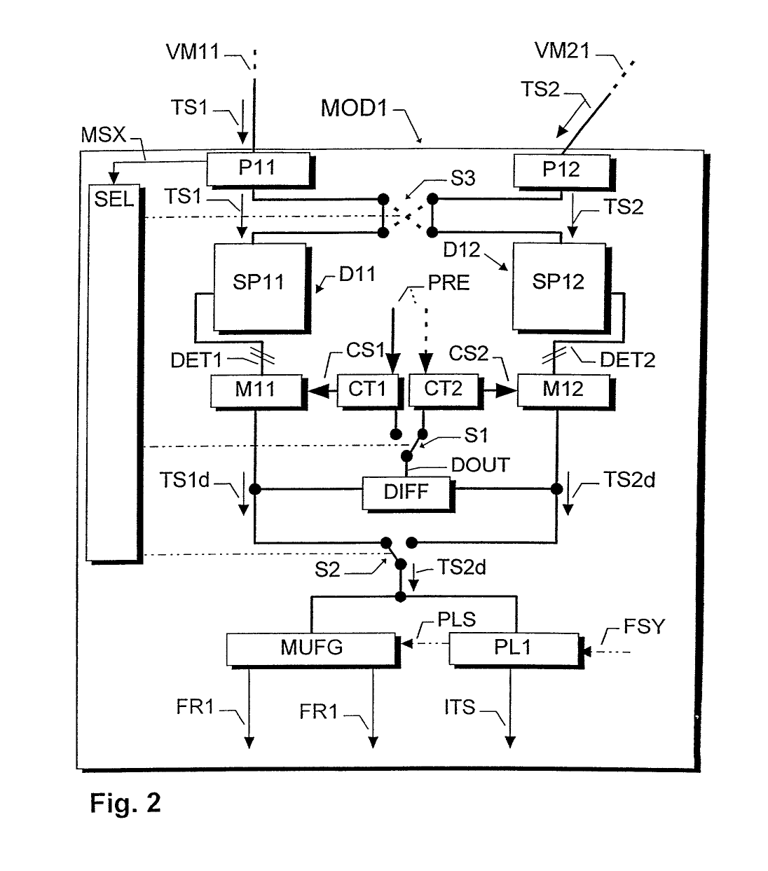

In the following a possible embodiment of a compensation module according to the invention will be explained making reference to the compensation module MOD1 schematically illustrated in FIG. 2. From a functional standpoint the compensation module MOD2 is of identical construction and therefore will not be described in detail. The illustrated components of the compensation module MOD1 can be constructed in the form of hardware, for example by means of one or more integrated circuit(s). For example, the compensation module MOD1 can consist entirely or partially for example of a so-called field programmable gate array (FPGA) and/or have the form of an application-specific integrated circuit (ASIC). The compensation module MOD1 can also be implemented as software in the form of a program module whose program code can be executed for example by a control processor of a switching matrix or another processor arrangement.

From the ports P11 and P12, the clock signals TS1, TS2 are fed to delay means D11, D12 which are provided to correct phase differences occurring between the clock signals TS1, TS2. The delay means comprise memories SP11, SP12, for example in the form of shift registers, and multiplexers M11, M12 for scanning their memory cells via connections DET1, DET2. By means of control values CS1, CS2, scanning locations and/or start values for the scanning of the memories SP11, SP12 can be pre-specified for the multiplexers M11, M12. At their output end the multiplexers M11, M12 emit the clock signals TS1, TS2 as delayed clock signals TS1d, TS2d.

The clock signals TS1d, TS2d serve to synchronise a multiple frame generator MUFG which, from the clock signals TS1d or TS2d, generates for example a frame clock FR1 with a frequency of 1 Hertz and a frame clock FR2 with a frequency of 8 Kilohertz. In the present case the clock signal TS1 serving as master synchronisation signal is switched to the multiple frame generator MUFG by means of a switch S1 operated by a change-over switch SEL. Additionally the master synchronisation signal TS1 is switched to a clock generator PL1 which for example has the form of a so-called phase locked loop (PLL). The clock generator PL1 emits a high-frequency clock ITS, for example at 622 Megahertz, and additionally synchronises the multiple frame generator MUFG with a synchronisation signal PLS. It is also possible to provide a fine synchronisation of the clock generator PL1 with one or more additional clock signal(s) (not shown) which are assigned to the clock signals TS1, TS2, for example with a clock signal of 2.43 Megahertz as is typically used for SDH technology.

Ideally the frame clocks FR1, FR2 formed by the multiple frame generator MUFG are substantially synchronous with the respective selected clock signal TS1d or TS2d. It is also possible for the frame clocks FR1, FR2 to be able to differ from the clock signals TS1d, TS2d within predefined tolerance limits. If such a tolerance limit is exceeded, the multiple frame generator MUFG automatically resynchronises itself or receives an external reset- or resynchronisation command, given for example by the clock generator PL1.

In the present embodiment of the compensation modules MOD1, MOD2, the clock signals TS1, TS2 can be alternately switched to the delay means D11, D12 by means of a two-way switch S3. The two-way switch S3 can consist of a hardware or software switch. In the illustrated switching position of the two-way switch S3, the clock signal TS1 is switched to the delay means D11 and the clock signal TS2 to the delay means D12, while the converse applies in a switching position shown in broken lines. The two-way switch S3 is controlled by the change-over switch SEL which forms a selection means and adjusts the switch position in accordance with the master-slave-status information MSX in the clock signals TS1, TS2. The master-slave-status information is determined by the ports P11, P12 and fed to the change-over switch SEL. In accordance with the master-slave-status information MSX, in the present case the clock signal TS1 is the master synchronisation signal and accordingly is switched to the delay means D11.

In principle the change-over switch SEL could also perform the switching operation in accordance with other criteria; for example the clock signal TS1, TS2 in each case leading in phase could be switched to the delay means D11 and the lagging clock signal of the clock signals TS1, TS2 could be switched to the delay means D12. Thus for example the memory SP11 would only have to possess half the memory depth of the memory SP12. In the present arrangement the two memories SP11, SP12 are of equal size so that the two-way switch S3 is not essential.

The delayed clock signals TS1d, TS2d are fed to a phase comparator DIFF which in each case determines the phase difference between the clock signals TS1d, TS2d and emits this phase difference as control signal DOUT. As a function of the relevant position of a switch S1, this signal is fed to a counter CT1 or a counter CT2 which serve as scanning control means and have the form of rotating counters clocked by a scanning clock signal (not shown). As a whole, the phase comparator DIFF and the counters CT1, CT2 form adjusting means which, in cooperation with the delay means D11, D12, can compensate a phase difference between the clock signals TS1d, TS2d.

In the illustrated position of the switch S1, the control signal DOUT is applied to the counter CT2 which, via the multiplexer M12, controls the scanning of the unselected clock signal TS2 serving as slave synchronisation signal.

Conversely, via the multiplexer M11 the counter CT1 controls the scanning of the selected clock signal TS1 serving as master synchronisation signal. The counter CT1 receives a preset value PRE as start value for the scanning of the memory SP11. The preset value PRE could also be switched to the counter CT2 (shown in broken lines), for example if the clock signal TS2 serves as the “selected” master synchronisation signal and the switch S1 is switched into the position not shown.

The scanning clock signal has a frequency of 78 Megahertz for example, and thus one scanning period TA amounts to 12.86 nanoseconds and is rounded up for example to 13 nanoseconds. If for example one assumes that the signal propagation time of the clock signals TS1, TS2 is 5 nanoseconds per metre and that the transmission paths VM11, VM21 have a minimum length of approximately 0 metres and a maximum length of 200 metres, the preset value PRE is for example 78 for a memory SP11 comprising for example 156 memory cells. Here the preset value PRE is set as a function of the (first) delay time VZ1, assigned to the (first) clock signal TS1, and of the memory depth of the memory SP11.

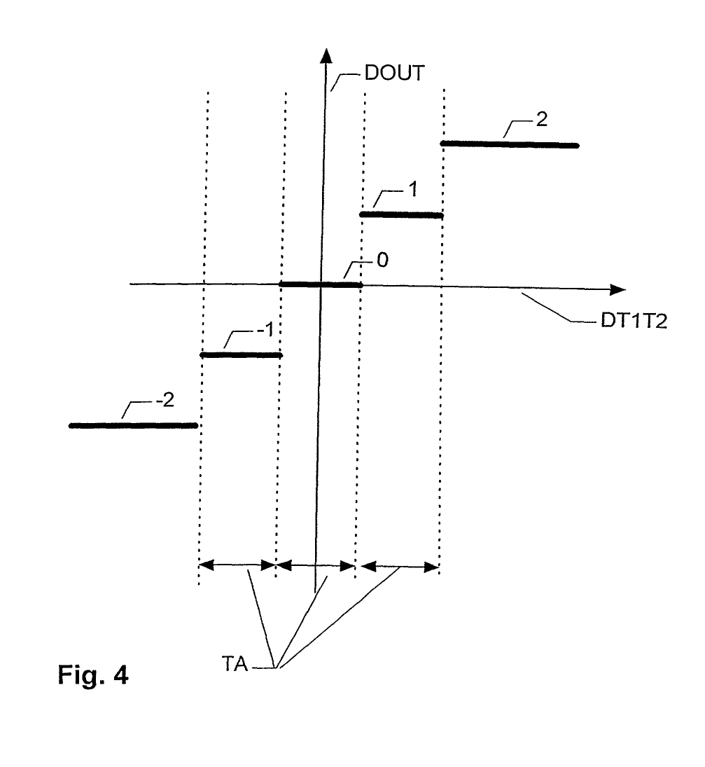

The preset value DOUT, which in the present case is switched to the counter CT2, consists of an incremental or decremental value which switches the counter CT2 forwards or backwards in stepped manner, and for which possible values are shown in FIG. 4. In FIG. 4 the phase differences between the delayed clock signals TS1d, TS2d serving as input value for the phase comparator DIFF have been plotted over a horizontal axis DT1T2.

If the clock signals TS1d, TS2d are only slightly shifted in phase, in the present case by one respective scanning period TA, the preset value DOUT is “0” or “no different”. In the event of a larger phase shift, for example of two scanning periods TA, the preset value DOUT is “−1” or “+1” depending upon whether the clock signal TS1d leads the clock signal TS2d or vice versa. If the phase shift is even greater, for example three and more scanning periods TA, the preset value DOUT is “−2” or “+2” or “leading substantially” or “lagging substantially”. In principle the preset value DOUT could also comprise fewer or more values.

In any case, following the phase adjustment of the delay means D12, the clock signals TS1d, TS2d are present in-phase in the switch S2, so that upon the failure of the clock signal TS1 or a fault therein, the switch S2 could readily be switched over to the clock signal TS2d by the change-over switch SEL serving as selection means.

Expediently, the two-way switch S3 is actuated only in the start-up phase of the network device NWE and/or the compensation modules MOD1, MOD2, while the switches S1, S2 can also be actuated during operation.

The switches S1, S2 are advantageously switched in synchronism. Conversely, the two-way switch S3 can be switched asynchronously to the switches S1, S2.

By switching the two-way switch S3 in the same direction, both compensation modules MOD1, MOD2 synchronise themselves with the same clock signal TS1 or TS2.

In the present arrangement it is in fact provided that in normal operation only one of the clock generator modules GEN1, GEN2 transmits a respective clock signal TS1, TS2 serving as master synchronisation signal, and the respective other clock generator module only sends a clock signal TS1, TS2 serving as standby- or slave synchronisation signal. If however a fault occurs, for example due to the failure of the connection VSY or one of the clock generator modules GEN1, GEN2, the synchronisation data SY are no longer correctly received by the two clock generator modules GEN1, GEN2. In this case the clock generator module(s) GEN1, GEN2, which is/are operating in fault-free fashion, so-to-speak automatically assume the master mode and set the master-slave-status information MSX in the clock signals TS1, TS2 at the values “master”.

If the compensation modules MOD1, MOD2 receive the clock signals TS1, TS2 at their respective two ports P11, P12; P21, P22 with an item of master-slave-status information MSX set at “master”, it can be predefined that they select the clock signal TS1 for example as master synchronisation signal. It is also possible for the clock signal TS2 for example to be selected as master synchronisation signal by the compensation modules MOD1, MOD2 even when the two clock signals TS1, TS2 are simultaneously set at “slave”.

Further variants of the invention are readily possible:

Instead of the delay means D11, D12 containing adjustable shift registers, differently designed delay means could also be provided, for example suitably constructed and/or programmed logic circuits, so that a smaller memory cell requirement may be needed.

The determination of the relevant phase differences between the clock signals TS1, TS2 and the analysis thereof for the adjustment of the delay means D11, D12 could also take place at the input end of the compensation modules MOD1, MOD2.

It will be obvious that the clock signals TS1, TS2 can also comprise further useful information, for example further quality identifiers and/or clock-time and/or date information. In principle however the clock signals TS1, TS2 could also have a simpler construction, for example as simple pulses in which an item of master-slave-status information is optionally contained.

Moreover, further compensation modules could also be provided.

The compensation modules MOD1, MOD2 could each be arranged in separate network devices arranged apart from one another, for example in respective SDH cross-connects or other computer systems.

In another configuration the compensation modules MOD1, MOD2 could be directly supplied with the external clock signals TEX1, TEX2 which could optionally contain an item of master-slave-status information.

It will be obvious that arbitrary combinations of the measures and arrangements described in the claims and in the description are likewise possible.

What is claimed is:

1. A compensation module for the phase compensation of clock signals, in particular a compensation module for a telecommunications network or for a network device of a telecommunications network, comprising receiving means for receiving at least one first clock signal and a second clock signal, wherein the compensation module comprising
first delay means for delaying the at least one first clock signal by a first delay time,
second delay means for delaying the second clock signal by a second delay time, and
adjusting means for the phase adjustment of the second delay means, so that the delayed, second clock signal, present at the output end of the second delay means, is adapted to the phase of the delayed, at least one first clock signal present at the output end of the first delay means.

2. A compensation module according to claim 1, wherein the first delay time and/or a start value for the second delay time are predetermined as a function of a maximum expected phase difference between the at least one first clock signal and the second clock signal and/or as a function of a maximum expected propagation time difference which is caused by transmission paths of different length used for the transmission of the at least one first clock signal and the second clock signal, respectively.

3. A compensation module according to claim 1, wherein the first delay means are designed such that they delay the at least one first clock signal by at least a first delay time which is such that it corresponds to a maximum expected phase difference and/or a maximum expected propagation time difference between the at least one first clock signal and the second clock signal, which difference is caused by transmission paths of different length used for the transmission of the at least one first clock signal and the second clock signal, respectively.

4. A compensation module according to claim 1, wherein the second delay means are designed such that they delay the at least one second clock signal by at least a second delay time which is such that it corresponds to twice a maximum expected phase difference and/or twice a maximum expected propagation time difference between the at least one first clock signal and the second clock signal, which difference is caused by transmission paths of different length used for the transmission of the at least one first clock signal and the second clock signal, respectively.

5. A compensation module according to claim 1, comprising selection means for selecting the at least one first delayed clock signal or the second delayed clock signal and/or the at least one first clock signal or the second clock signal, where the respective selected, at least one first delayed clock signal or second delayed clock signal and/or at least one first clock signal or second clock signal serves in particular to synchronise the compensation module.

6. A compensation module according to claim 5, wherein the selection means are designed to select, for delay in the first delay means, that one of the at least one first clock signal or second clock signal which is identified by an item of master-slave-status information as a master synchronisation signal or which leads the respective other first or second clock signal in phase.

7. A compensation module according to claim 5, wherein the selection means are designed to select the at least one first delayed clock signal or the second delayed clock signal while the compensation module is in operation.

8. A compensation module according to claim 1, wherein the adjusting means are designed to adjust the phase of the first delay means so that in particular when the first delayed clock signal is selected instead of the second delayed clock signal, the delayed first clock signal, present at the output end of the first delay means, is adapted to the phase of the delayed second clock signal present at the output end of the second delay means.

9. A compensation module according to claim 1, wherein the adjusting means are designed to preferentially adjust the first delay time and/or second delay time to a first or second start value which is either predetermined and/or is determined upon each start-up of the compensation module, where a modification of the first delay time or second delay time, which increases the deviation of the first delay time or second delay time from the first or second start value respectively, is performed only upon the attainment of a predetermined first deviation tolerance value, while the converse applies upon the attainment of a second deviation tolerance value which is smaller than the first deviation tolerance value.

10. A compensation module according to claim 1, wherein the adjusting means are designed such that, for the phase adjustment, they change the second delay time in stepped fashion.

11. A compensation module according to claim 1, wherein the adjusting means are designed such that, for the phase adjustment, they change the second delay time of the second delay means in dynamic step sizes, the respective step size being modified as a function of a respective phase difference between the delayed second clock signal, present at the output end of the second delay means, and the delayed first clock signal present at the output end of the first delay means.

12. A compensation module according to claim 1, comprising program code which can be executed by a control means of a network device, in particular a control means on a console of a network device for a transmission network with a synchronous digital hierarchy.

13. A memory means, in particular a floppy disc, CD-ROM, digital versatile disc, hard disc-drive or the like, with a compensation module according to claim 12 stored thereon.

14. A network device, in particular a network device for a transmission network with a synchronous digital hierarchy, with at least one compensation module according to claim 1 and/or claim 12.

15. A method of phase compensation between at least one first clock signal and a second clock signal which are transmitted to a compensation module, in particular a compensation module in a telecommunications network or in a network device of a telecommunications network, comprising the steps of
delaying by the compensation module the at least one first clock signal by a predetermined first delay time to form a delayed first clock signal,
delaying by the compensation module the second clock signal by a predetermined second delay time to form a delayed second clock signal, and
modifying by the compensation module the second delay time such that the delayed second clock signal is adapted to the phase of the delayed, at least one first clock signal.
